(19) United States
(12) Patent Application Publication
(10) Pub. No.: US 2024/0098482 A1
(43) Pub. Date: Mar. 21, 2024

(54) CONTEXT SPECIFIC ALERTS FOR USER EQUIPMENTS

(71) Applicant: QUALCOMM Incorporated, San Diego, CA (US)

(72) Inventors: Dan VASSILOVSKI, Del Mar, CA (US); Shailesh PATIL, San Diego, CA (US); Anantharaman BALASUBRAMANIAN, San Diego, CA (US); Gene Wesley MARSH, San Diego, CA (US); Nileshkumar PAREKH, San Diego, CA (US)

(21) Appl. No.: 17/933,762

(22) Filed: Sep. 20, 2022

(51) Int. Cl. H04W 8/24; H04W 48/16; H04W 68/00; H04W 72/04

(52) U.S. Cl. CPC H04W 8/24; H04W 48/16; H04W 68/005; H04W 72/048

(57) ABSTRACT

Method and apparatus for context specific alerts for autonomous and non-autonomous vehicles. The apparatus obtains a capability indication of a UE, the capability indication indicating that the UE is paired with a vehicle. The apparatus generates vehicle specific signals based on the capability indication indicating that the UE is paired with the vehicle. The apparatus outputs the vehicle specific signals to the UE. The vehicle comprising an autonomous vehicle, where the capability indication further indicates that an autonomous mode of the autonomous vehicle is engaged or disengaged. Data within the vehicle specific signals is tailored to a paired combination of the UE and the vehicle.

### TECHNICAL FIELD

The present disclosure relates generally to communication systems, and more particularly, to a configuration for context specific alerts for user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a network node. The device may be a processor and/or a modem at a network node or the network node itself. The apparatus obtains a capability indication of a user equipment (UE), the capability indication indicating that the UE is paired with a vehicle. The apparatus generates vehicle specific signals based on the capability indication indicating that the UE is paired with the vehicle. The apparatus outputs the vehicle specific signals to the UE.

In an aspect of the disclosure, a method, a computer-readable medium, and an apparatus are provided. The apparatus may be a device at a UE. The device may be a processor and/or a modem at a UE or the UE itself. The apparatus transmits, to a network entity, a capability indication of the UE, the capability indication indicating that the UE is paired with a vehicle. The apparatus receives, from the network entity, vehicle specific signals based on the capability indication indicating that the UE is paired with the vehicle.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of autonomous vehicles and non-autonomous vehicles in an access network.

FIG. 5 is a diagram illustrating an example of autonomous vehicles and non-autonomous vehicles in an access network.

FIG. 6 is a call flow diagram of signaling between a UE and a base station.

FIG. 7 is a flowchart of a method of wireless communication.

FIG. 8 is a diagram illustrating an example of a hardware implementation for an example network entity.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

### DETAILED DESCRIPTION

Development of vehicle autonomous driving capabilities is an ongoing world-wide effort spanning industry and academia. Autonomous vehicles may be configured to enable operation with closer vehicle spacing and reduced reaction time. With advances in processing power, autonomous vehicles may be capable of ingesting and processing large amounts of data to assess the environment and enable inter-vehicle maneuver coordination. Development of vehicle-based sensor sharing and cloud-based sensor sharing may allow for detection and dissemination of other vehicles, vulnerable road users (e.g., pedestrians, cyclists) or road features.

Human drivers and autonomous vehicles may operate with different characteristics, including reaction time to detected vehicles, road users, or road conditions, and how closely to other vehicles and road features they may operate. In a hybrid environment of both autonomous vehicles and non-autonomous vehicles, dissemination of sensor sharing data and maneuver requests may be tailored to the capabilities of the receiving vehicle, whether the vehicle is an autonomous vehicle with autonomous mode engaged/disengaged or a non-autonomous vehicle.

Aspects presented herein provide a configuration for context specific alerts for autonomous vehicles and non-autonomous vehicles. For example, the aspects presented herein may identify a set of criteria or over-the-air signaling for a network entity to provide vehicle specific sensor sharing data (e.g., vehicle road users, non-vehicular road users, or road conditions) to autonomous vehicles with autonomous functionality engaged, autonomous vehicles with the autonomous functionality disengaged, or non-autonomous vehicles.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, e.g., via a virtual central unit, a virtual distributed unit, a virtual radio unit, or some combination thereof, or the like.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

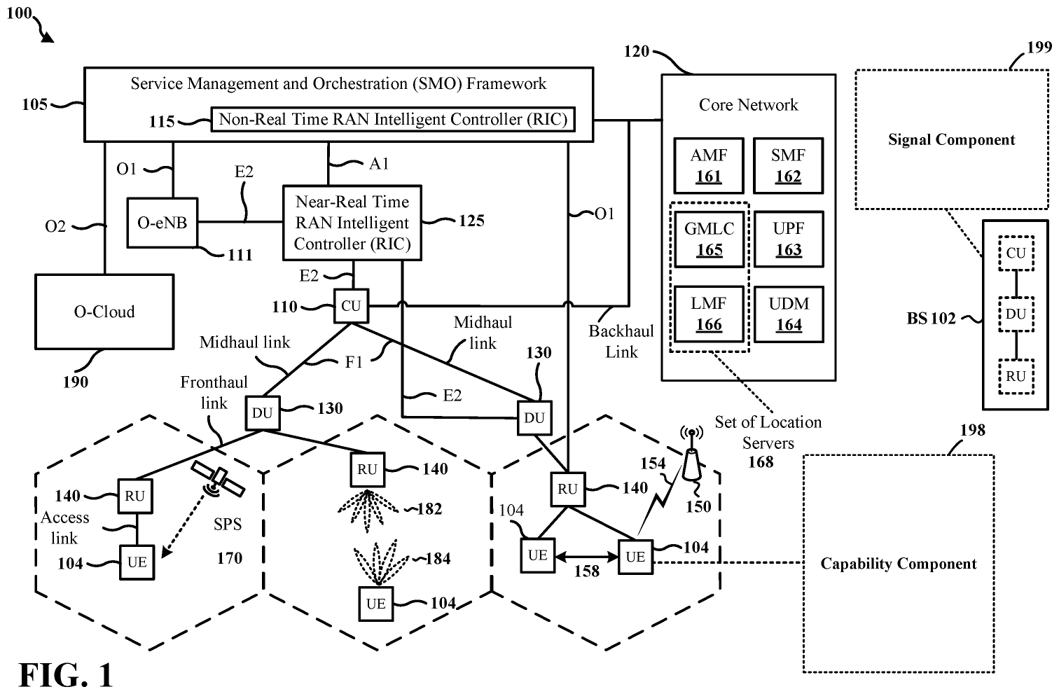

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, roadside unit (RSU), or some other suitable terminology. An RSU may comprise a fixed PC5/sidelink node that has network connectivity and configured to communicate wirelessly with a mobile PC5/sidelink UE (e.g., vehicles). A vehicle communication path to network entities may be via cellular (e.g., Uu), for example via a gNB, or may be via PC5/sidelink via an RSU. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle (e.g., a UE comprised within an autonomous vehicle or non-autonomous vehicle), an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a capability component 198 configured to transmit, to a network entity, a capability indication of the UE, the capability indication indicating that the UE is paired with a vehicle; and receive, from the network entity, vehicle specific signals based on the capability indication indicating that the UE is paired with the vehicle.

Referring again to FIG. 1, in certain aspects, the base station 102 may comprise a signal component 199 configured to obtain a capability indication of a UE, the capability indication indicating that the UE is paired with a vehicle; generate vehicle specific signals based on the capability indication indicating that the UE is paired with the vehicle; and output the vehicle specific signals to the UE.

Although the following description may be focused on 5G NR, the concepts described herein may be applicable to other similar areas, such as LTE, LTE-A, CDMA, GSM, and other wireless technologies.

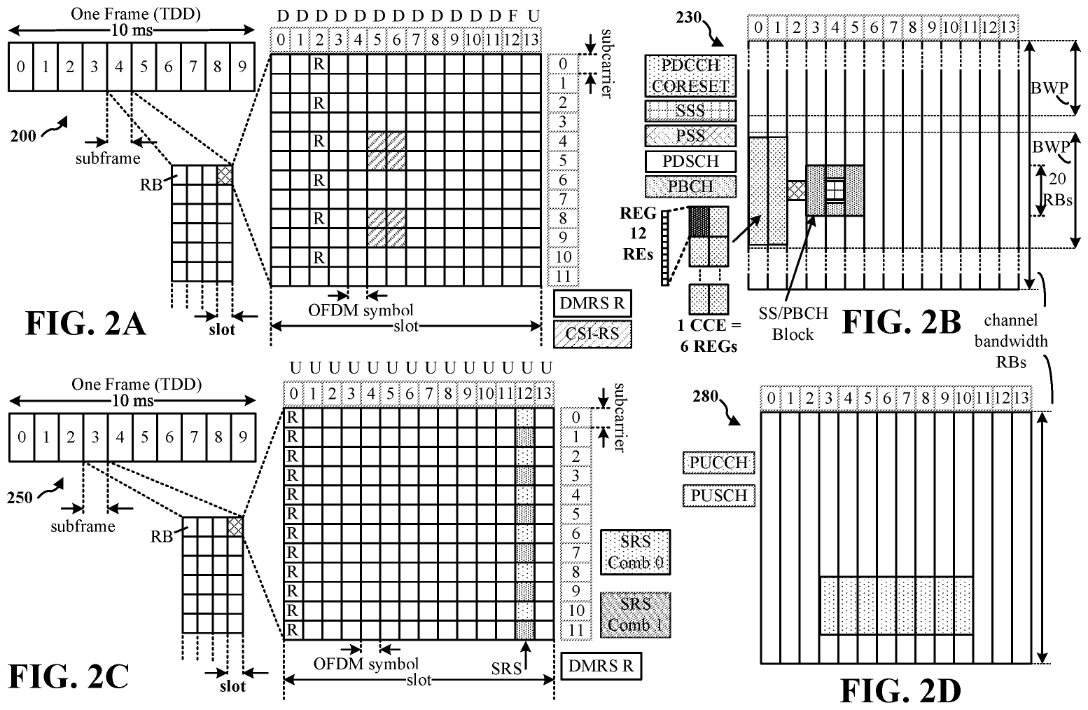

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

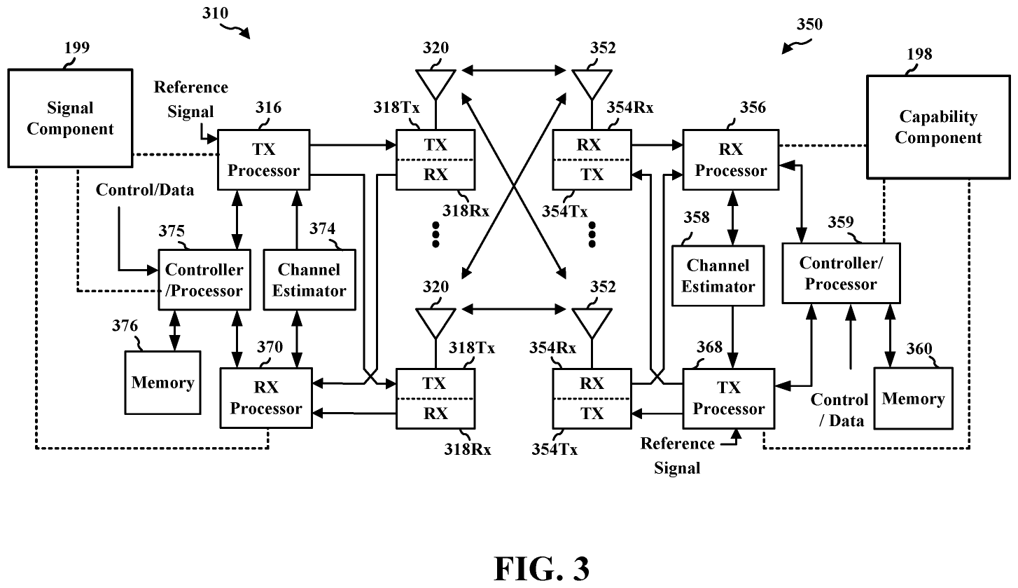

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the capability component 198 of FIG. 1.

At least one of the TX processor 316, the RX processor 370, and the controller/processor 375 may be configured to perform aspects in connection with the signal component 199 of FIG. 1.

Development of vehicle autonomous driving capabilities is an ongoing world-wide effort spanning industry and academia. Autonomous vehicles may be configured to enable operation with closer vehicle spacing and reduced reaction time. With advances in processing power, autonomous vehicles may be capable of ingesting and processing large amounts of data to assess the environment and enable inter-vehicle maneuver coordination. Development of vehicle-based sensor sharing and cloud-based sensor sharing may allow for detection and dissemination of other vehicles, vulnerable road users (VRU) (e.g., pedestrians, cyclists) or road features.

Human drivers and autonomous vehicles may operate with different characteristics, including reaction time to detected vehicles, road users, or road conditions, and how closely to other vehicles and road features they may operate. In a hybrid environment of both autonomous vehicles and non-autonomous vehicles, dissemination of sensor sharing data and maneuver requests may be tailored to the capabilities of the receiving vehicle, whether the vehicle is an autonomous vehicle with autonomous mode engaged/disengaged or a non-autonomous vehicle. Identifying criteria and mechanisms for customizing data distribution to vehicles based on their AV capability may allow for successful deployment of autonomous vehicles.

Aspects presented herein provide a configuration for context specific alerts for autonomous vehicles and non-autonomous vehicles. For example, the aspects presented herein may identify a set of criteria or over-the-air signaling for a network entity to provide vehicle specific sensor sharing data (e.g., vehicle road users, non-vehicular road users, or road conditions) to autonomous vehicles with autonomous functionality engaged, autonomous vehicles with the autonomous functionality disengaged, or non-autonomous vehicles. At least one advantage of the disclosure is that the vehicle specific sensor sharing data may be communicated over a cellular wireless network (e.g., Uu) or via sidelink communication (e.g., PC5) at the application or lower layers.

Human-driven, autonomous vehicle may be distinguished by their respective ability to ingest and react to environmental data (e.g., other road vehicles, VRUs, or road hazards). Autonomous vehicles may be able to consume and process much larger volumes of data, including data beyond a human driver's field of view. With regards to reaction time, human reaction time may rely on human perception reaction time, which may, for example, be as long or longer than 2.5 seconds, while autonomous vehicles may be able to react in sub-second time. With regards to data ingestion amount, autonomous vehicles are able to receive and/or process large number of objects (e.g., vehicles, VRUs, or road hazards) disseminated from other vehicles or from the network. However, human drivers may only react or account for objects (e.g., obstacles VRUs disseminated via sensor sharing from other vehicles or from the network) within their visible surroundings or objects which are perceived by the human driver. A field of view for human drivers or the ability to perceive objects varies from person to person, and may not be substantially similar from person to person. With regards to range of data, human drivers are limited to the human driver field of view. A human field of view may be constrained by a direction the human is looking, as well as environmental conditions, such as but not limited to lighting conditions (e.g., day vs. night), precipitation (e.g., snow, fog, hail, etc.), oncoming vehicles (e.g., headlight blinding), or other (e.g., smoke). Autonomous vehicle or non-autonomous field of view may provide more coverage in comparison to a somewhat narrow human field of view, for example, by employing a variety of sensors to provide possibly up to a 360-degree field of view (e.g., deploying one or more cameras, one or more radars, one or more sonars, one or more laser based sensors, or the like). Further still, some example vehicles may be able to process received data corresponding to one or more areas beyond a sensor field of view, and incorporate such data into a decision engine and planned travel route.

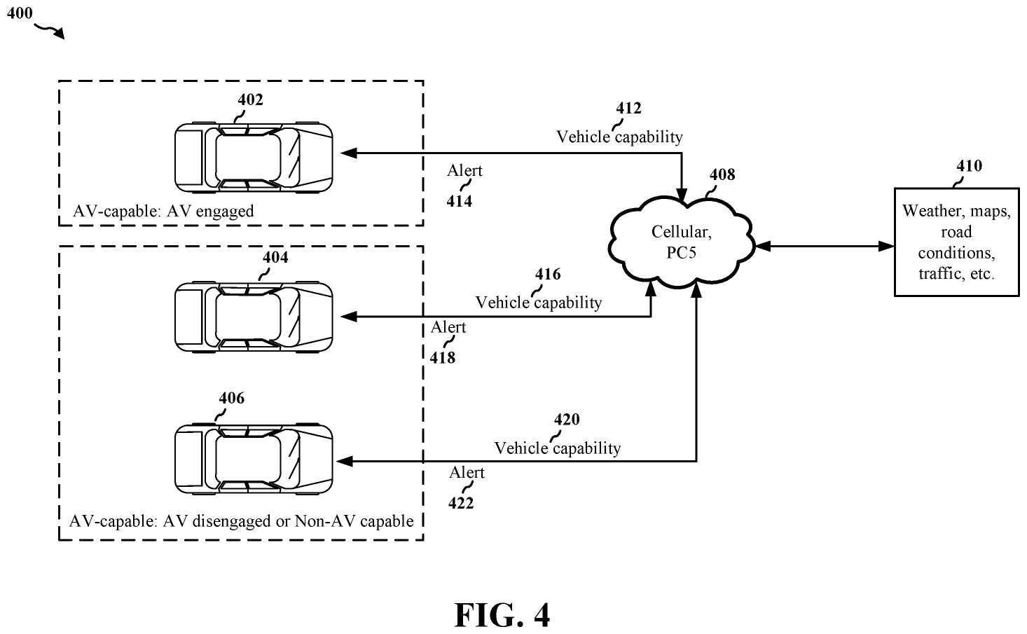

FIG. 4 is a diagram 400 illustrating an example of autonomous vehicles and non-autonomous vehicles in an access network. In the diagram 400 comprises an autonomous vehicle (AV) 402, an AV 404, and a non-AV 406. The AV 402 may have an autonomous mode engaged. The AV 404 may have an autonomous mode disengaged. The AV 402 may communicate with the network entity 408 and provide a vehicle capability 412 via application-layer, PC5, or Uu, where Uu may include application-layer messages, RRC messages or lower-layer signaling (e.g., MAC-CE), and PC5 may include application-layer messages, PC5-RRC, PC5-signaling, or lower-layer signaling (e.g., MAC-CE). The vehicle capability 412 may indicate to the network the data processing capabilities of the AV 402 while having the autonomous mode engaged. The AV 402 may receive an alert 414 tailored for the AV 402 based on the vehicle capability 412. The AV 404 may communicate with the network entity 408 and provide a vehicle capability 416 via application-layer, PC5, or Uu (e.g., signaling, MAC-CE). The vehicle capability 416 may indicate to the network the data processing capabilities of the AV 404 while having the autonomous mode disengaged. The AV 404 may receive an alert 418 tailored for the AV 404 based on the vehicle capability 416. The non-AV 406 may communicate with the network entity 408 and provide a vehicle capability 420 via application-layer, PC5, or Uu (e.g., signaling, MAC-CE). The vehicle capability 420 may indicate to the network the data processing capabilities of the non-AV 406. The non-AV 406 may receive an alert 422 tailored for the non-AV 406 based on the vehicle capability 420.

The network entity 408 may receive environmental information 410, from the network, related to the weather, maps, road conditions, traffic, or the like. The environmental information 410 may be harvested from other vehicles or third party sources, and the network entity 408 may be configured to issue vehicle specific guidance to the AV (e.g., 402, 404) or the non-AV 406.

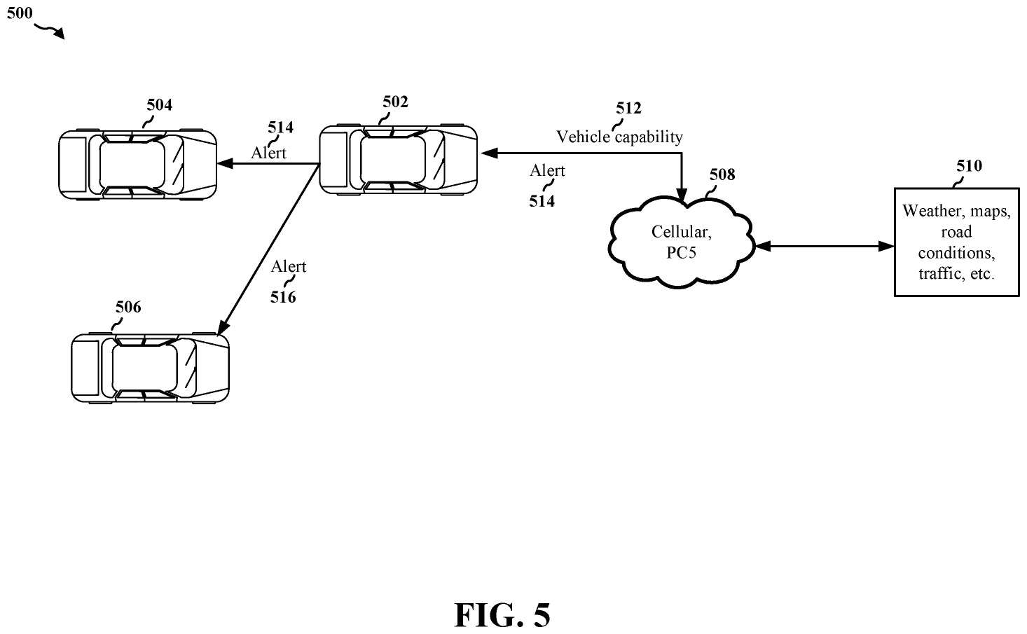

FIG. 5 is a diagram 500 illustrating an example of autonomous vehicles and non-autonomous vehicles in an access network. In some instances, a vehicle may relay alerts from the network to one or more other vehicles. For example, as shown in diagram 500, an AV 502 may provide a vehicle capability 512 to the network 508, and the network 508 may provide an alert 514 which may comprise environmental information 510 based on the vehicle capability 512. In some instances, the AV 502 may act as a relay source and relay the alert 514 to one or more vehicles. For example, the AV 502 may relay the alert 514 to AV 504. The AV 504 may have an autonomous mode engaged or disengaged. In instances where the AV 504 has the autonomous mode engaged, the AV 504 may utilize the alert 514. However, in some instances, not all of the vehicles may be AV capable. For example, some vehicle may be non-AVs (e.g., 506). In such instances, the AV 502 may still relay the alert 516 to the non-AV 506, but the non-AV 506 may not be able to utilize the alert 516 or may only be able to utilize part of the alert 516. In some aspects, the AV 502 may tailor the alert (e.g., 514, 516) based on the type of vehicle (e.g., AV with autonomous mode engaged/disengaged or a non-AV). The AV 502 may tailor the alert based on the type of vehicle based on a capability indication received from the one or more vehicles. In yet some instances, the AV 502 may modify the alert (e.g., 514, 516) relayed to other vehicles (e.g., 504, 506) to provide a baseline alert that may be utilized by any vehicle.

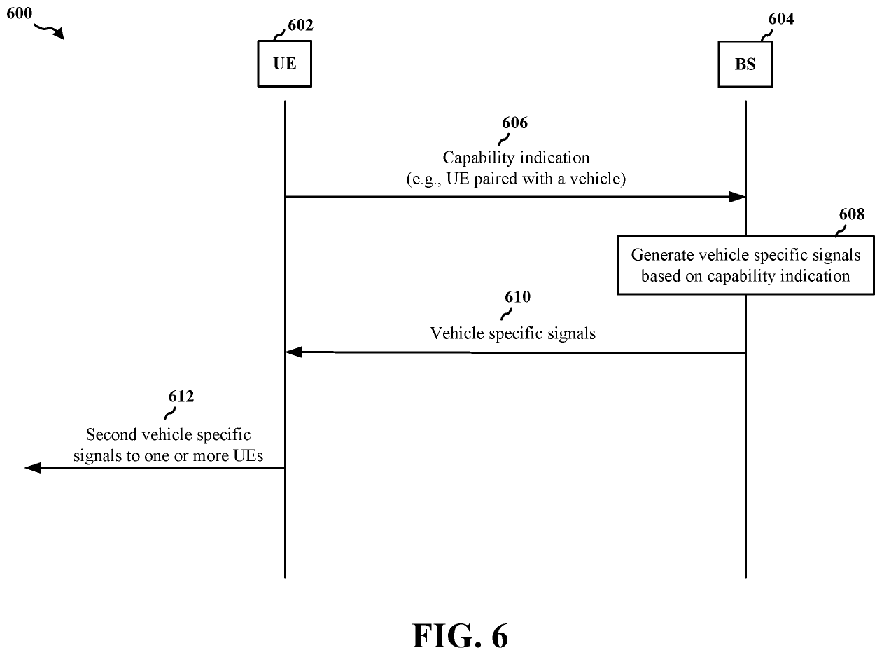

FIG. 6 is a call flow diagram 600 of signaling between a UE 602 and a base station 604. The base station 604 may be configured to provide at least one cell. The UE 602 may be configured to communicate with the base station 604. For example, in the context of FIG. 1, the base station 604 may correspond to base station 102 and. Further, a UE 602 may correspond to at least UE 104. In another example, in the context of FIG. 3, the base station 604 may correspond to base station 310 and the UE 602 may correspond to UE 350.

At 606, the UE 602 may transmit a capability indication of the UE to the base station 604. The base station 604 may receive the capability indication of the UE from the UE 602. The capability indication may indicate that the UE 602 is paired with a vehicle. The term “paired” as used herein is used to indicate that a UE is communicatively coupled to a vehicle, such that the UE and the vehicle may communicate to each other. The UE and vehicle may be communicatively coupled (e.g., paired) via a wired or wireless connection. In addition, unless otherwise stated, such terms as used herein and/or in the claims are not necessarily intended to be limited to just one particular communication protocol or system. The vehicle may comprise an autonomous vehicle or a non-autonomous vehicle. In some instances, the capability indication may indicate that the UE is paired with an autonomous vehicle or a non-autonomous vehicle. In some aspects, the capability indication may indicate that an autonomous mode of the autonomous vehicle is engaged or disengaged. In some aspects, the capability indication may be comprised within a wireless communication. In such aspects, the vehicle specific signals may be comprised within at least one of application-layer messages, RRC messages, or physical-layer messages. In some aspects, the capability indication may be comprised within a short-range wireless communication. For example, the capability indication may be comprised within a short range wireless device-to-device communication protocol (e.g., sidelink, WiFi, or dedicated short range communication (DSRC)). The vehicle specific signals may be comprised within at least one of application-layer messages, RRC messages, or physical-layer messages.

At 608, the base station 604 may generate vehicle specific signals based on the capability indication indicating that the UE 602 is paired with the vehicle. In some aspects, data within the vehicle specific signals may be tailored for the UE paired with the vehicle. For example, the data within the vehicle specific signals may be tailored for a paired combination of the UE and the vehicle. In some aspects, the vehicle may comprise the autonomous vehicle, such that an autonomous mode of the autonomous vehicle is engaged. Autonomous vehicles may have one or more autonomous modes, where the one or more autonomous modes have different levels of autonomous operation. For example, autonomy in vehicles may be categorized in six levels, according to a system developed by the Society of Automotive Engineers (SAE) International (e.g., SAE J3016). The SAE levels may be categorized as Level 0—no automation, a human driver does everything; Level 1—hands on/shared control, where an automated system can sometimes assist a human driver conduct some parts of the driving task; Level 2—hands off, where an automated system can actually conduct some parts of the driving task, while a human continues to monitor the driving environment and performs the rest of the driving task; Level 3—eyes off, where an automated system can both actually conduct some parts of the driving task and monitor the driving environment in some instances, but a human driver must be ready to take back control when the automated system requests; Level 4—mind off, where an automated system can conduct the driving task to monitor the driving environment, and a human need not take back control, but the automated system can operate only in certain environments and under certain conditions; and Level 5—steering wheel optional, where an automated system can perform all driving tasks, under all conditions that a human driver could perform them. In some instances, some of the data may correspond to one or more other vehicles, one or more road users, one or more road conditions, one or more traffic conditions, a field of view of one or more sensors, one or more depths, one or more ranges, or the like, or some combination thereof. In some aspects, in instances where the vehicle comprises a non-autonomous vehicle, at least a portion of the data may comprise at least information associated with a vicinity of the non-autonomous vehicle for the UE paired with the non-autonomous vehicle. In some aspects, in instances where the vehicle comprises an autonomous vehicle, at least a portion of the data may comprise at least information associated with a vicinity of the autonomous vehicle for the UE paired with the autonomous vehicle for use by the autonomous vehicle while an autonomous mode of the autonomous vehicle is disengaged. In some aspects, information of a vicinity of the non-autonomous vehicle for the UE paired with the non-autonomous vehicle or the vicinity of the autonomous vehicle for the UE paired with the autonomous vehicle may correspond to all or part of an estimated field of view of an operator of the non-autonomous vehicle, the autonomous vehicle, or both. In some aspects, an operator of an autonomous vehicle may comprise a remotely located operator capable of affecting at least some operation of the autonomous vehicle. In yet some aspects, an operator of a non-autonomous vehicle or an autonomous vehicle may comprise a driver or other operator situated within the vehicle. In some aspects, in instances where the vehicle comprises a non-autonomous vehicle, the data within the vehicle specific signals may be based, at least in-part, on an indication of an estimated or expected reaction time of an operator of the vehicle. In some aspects, in instances where the vehicle comprises an autonomous vehicle, the data within the vehicle specific signals may be based, at least in-part, on an expected data processing capability of the autonomous vehicle, an estimated or expected reaction time of an operator of the autonomous vehicle, or both.

At 610, the base station 604 may output the vehicle specific signals. The base station 604 may output (e.g., generate, transmit, etc.) vehicle specific signals to the UE 602. The UE 602 may be paired with the vehicle. The UE 602 may receive the vehicle specific signals from the base station 604 or possibly another network entity. The transmission of the vehicle specific signals may comprise one or more application-layer messages, one or more radio resource control (RRC) messages, or one or more physical-layer messages. In some aspects, the vehicle specific signals may comprise content specific alerts. The content specific alerts may be intended for use by the paired UE alone, in a distributed manner by the UE and the vehicle, in a separate manner by the UE and by the vehicle, or may be passed through to the vehicle by the UE for processing by the vehicle. For example, the paired UE may receive a content specific alert that is intended to be transmitted to another UE, such that only the paired UE only utilizes the content specific alert. In another example, the UE may receive a context specific alert comprising map information, where the UE may utilize the map information to plot a route, while the vehicle may utilize the map information to be aware of upcoming road conditions, such that the UE and the vehicle utilize the content specific alert in a distributed manner. In another example, the UE may receive a context specific alert comprising traffic conditions which may be utilized by the UE to calculate a new route in view of the traffic conditions, while the vehicle may utilize the context specific alert to engage/disengage an operational mode of the vehicle in response to the context specific alert, such that the UE and the vehicle utilize the context specific alert for different purposes. In another example, the UE may receive a context specific alert comprising an indication of an upcoming obstacle nearby, such that the UE passes the context specific alert for processing by the vehicle.

At 612, the UE 602 may transmit a second vehicle specific signal to one or more UEs (not shown) via sidelink communication. In some aspects, each of the one or more UEs (not shown) may be paired with a respective autonomous vehicle or a respective non-autonomous vehicle, wherein the UE 602 and the one or more UEs (not shown) may be within a group of UEs or may be within a threshold vicinity of each other. In some aspects, vehicle specific signals may be transmitted, by the UE 602, to the one or more UEs. The vehicle specific signals may be transmitted via broadcast, groupcast, or unicast. In some aspects, the second vehicle specific signal may be processed to correspond with vehicle capabilities of the one or more UEs, based on the vehicle specific signals received by the first UE (e.g., UE 602) from the network entity. In some aspects, the second vehicle specific signal may comprise at least a portion of vehicle specific signals received by the first UE from the network entity.

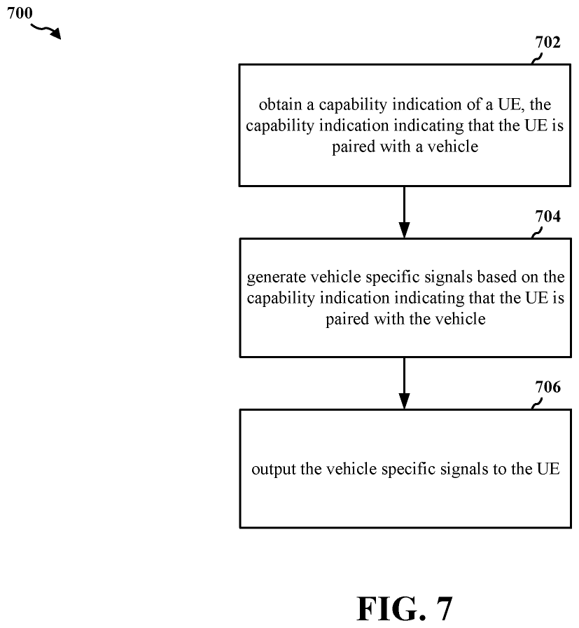

FIG. 7 is a flowchart 700 of a method of wireless communication. The method may be performed by a base station (e.g., the base station 102; the network entity 802. One or more of the illustrated operations may be omitted, transposed, or contemporaneous. The method may provide vehicle specific sensor sharing data to autonomous vehicles or non-autonomous vehicles.

At 702, the network entity may obtain a capability indication of a UE. For example, 702 may be performed by signal component 199 of network entity 802. The capability indication may indicate that the UE is paired with a vehicle. The vehicle may comprise an autonomous vehicle or a non-autonomous vehicle. In some instances, the capability indication may indicate that the UE is paired with an autonomous vehicle or a non-autonomous vehicle. In some aspects, the capability indication may indicate that an autonomous mode of the autonomous vehicle is engaged or disengaged. In some aspects, the capability indication may be comprised within a wireless communication. The wireless communication comprising the capability indication may be received via a transceiver of the network entity. In some aspects, the capability indication may be comprised within a short-range wireless communication. For example, the capability indication may be comprised within a short range wireless device-to-device communication protocol (e.g., sidelink, WiFi, or DSRC). The vehicle specific signals may be comprised within at least one of application-layer messages, RRC messages, or physical-layer messages.

At 704, the network entity may generate vehicle specific signals. For example, 704 may be performed by signal component 199 of network entity 802. The network entity may generate the vehicle specific signals based on the capability indication indicating that the UE is paired with the vehicle. In some aspects, data within the vehicle specific signals may be tailored for the UE paired with the vehicle. For example, the data within the vehicle specific signals may be tailored for a paired combination of the UE and the vehicle. In some aspects, the vehicle may comprise the autonomous vehicle, such that an autonomous mode of the autonomous vehicle is engaged. In such instances, some of the data may correspond to one or more other vehicle or otherwise known vehicles, one or more road users, one or more road conditions, one or more traffic conditions, a field of view of one or more sensors, one or more depths, one or more ranges, or the like, or some combination thereof. In some aspects, in response to the vehicle comprising a non-autonomous vehicle, at least a portion of the data may comprise at least information associated with a vicinity of the non-autonomous vehicle for the UE paired with the non-autonomous vehicle. In some aspects, in response to the vehicle comprising an autonomous vehicle, at least a portion of the data may comprise at least information associated with a vicinity of the autonomous vehicle for the UE paired with the autonomous vehicle for use by the autonomous vehicle while an autonomous mode of the autonomous vehicle is disengaged. In some aspects, information of a vicinity of the non-autonomous vehicle for the UE paired with the non-autonomous vehicle or the vicinity of the autonomous vehicle for the UE paired with the autonomous vehicle may correspond to an estimated field of view of an operator of the vehicle. In some aspects, an operator of an autonomous vehicle may comprise a remotely located operator capable of affecting at least some operation of the autonomous vehicle. In yet some aspects, an operator of a non-autonomous vehicle or an autonomous vehicle may comprise a driver or other operator situated within the vehicle. In some aspects, in response to the vehicle comprising a non-autonomous vehicle, the data within the vehicle specific signals may be based, at least in-part, on an indication of an estimated or expected reaction time of an operator of the non-autonomous vehicle. In some aspects, in response to the vehicle comprising an autonomous vehicle, the data within the vehicle specific signals may be based, at least in-part, on an expected data processing capability of the autonomous vehicle, an estimated or expected reaction time of an operator of the autonomous vehicle, or both.

At 706, the network entity may output the vehicle specific signals. For example, 706 may be performed by signal component 199 of network entity 802. The network entity may output the vehicle specific signals to the UE. The UE being paired to the vehicle (e.g., an autonomous vehicle or a non-autonomous vehicle). The transmission of the vehicle specific signals may comprise one or more application-layer messages, one or more RRC messages, or one or more physical-layer messages. In some aspects, a processor associated with the signal component may be configured to output the vehicle specific signals by initiating transmission of the vehicle specific signals via a transceiver.

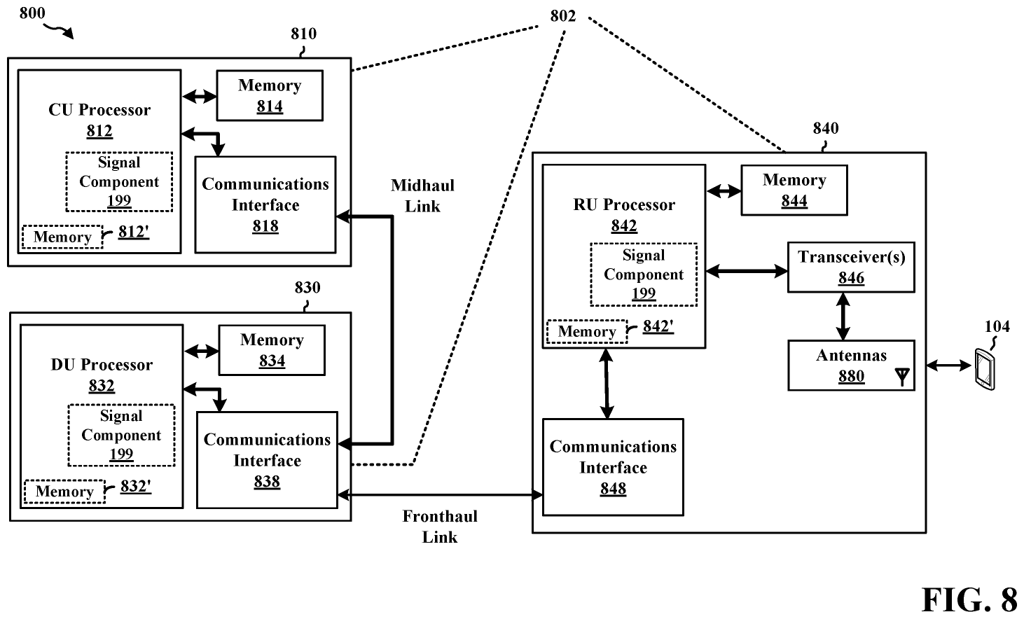

FIG. 8 is a diagram 800 illustrating an example of a hardware implementation for a network entity 802. The network entity 802 may be a BS, a component of a BS, or may implement BS functionality. The network entity 802 may include at least one of a CU 810, a DU 830, or an RU 840. For example, depending on the layer functionality handled by the component 199, the network entity 802 may include the CU 810; both the CU 810 and the DU 830; each of the CU 810, the DU 830, and the RU 840; the DU 830; both the DU 830 and the RU 840; or the RU 840. The CU 810 may include a CU processor 812. The CU processor 812 may include on-chip memory 812′. In some aspects, the CU 810 may further include additional memory modules 814 and a communications interface 818. The CU 810 communicates with the DU 830 through a midhaul link, such as an F1 interface. The DU 830 may include a DU processor 832. The DU processor 832 may include on-chip memory 832′. In some aspects, the DU 830 may further include additional memory modules 834 and a communications interface 838. The DU 830 communicates with the RU 840 through a fronthaul link. The RU 840 may include an RU processor 842. The RU processor 842 may include on-chip memory 842′. In some aspects, the RU 840 may further include additional memory modules 844, one or more transceivers 846, antennas 880, and a communications interface 848. The RU 840 communicates with the UE 104. The on-chip memory 812′, 832′, 842′ and the additional memory modules 814, 834, 844 may each be considered a computer-readable medium/memory. Each computer-readable medium/memory may be non-transitory. Each of the processors 812, 832, 842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain a capability indication of a UE, the capability indication indicating that the UE is paired with a vehicle; generate vehicle specific signals based on the capability indication indicating that the UE is paired with the vehicle; and output the vehicle specific signals to the UE. The component 199 may be within one or more processors of one or more of the CU 810, DU 830, and the RU 840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 802 may include a variety of components configured for various functions. In one configuration, the network entity 802 includes means for obtaining a capability indication of a UE, the capability indication indicating that the UE is paired with a vehicle. The network entity includes means for generating vehicle specific signals based on the capability indication indicating that the UE is paired with the vehicle. The network entity includes means for outputting the vehicle specific signals to the UE. The means may be the component 199 of the network entity 802 configured to perform the functions recited by the means. As described supra, the network entity 802 may include the TX processor 316, the RX processor 370, and the controller/processor 375. As such, in one configuration, the means may be the TX processor 316, the RX processor 370, and/or the controller/processor 375 configured to perform the functions recited by the means.

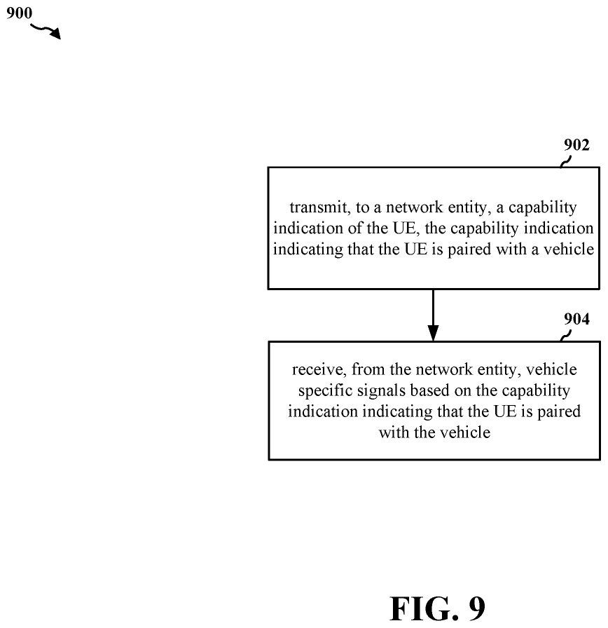

FIG. 9 is a flowchart 900 of a method of wireless communication. The method may be performed by a UE (e.g., the UE 104; the apparatus 1104). One or more of the illustrated operations may be omitted, transposed, or contemporaneous. The method may UEs to receive vehicle specific sensor sharing data based on whether the UE is comprised within an autonomous vehicle or comprised within a non-autonomous vehicle.

At 902, the UE may transmit a capability indication of the UE. For example, 902 may be performed by capability component 198 of apparatus 1104. The UE may transmit the capability indication of the UE to a network entity. The capability indication may indicate that the UE is paired with a vehicle. The vehicle may comprise an autonomous vehicle or a non-autonomous vehicle. In some instances, the capability indication may indicate that the UE is paired with an autonomous vehicle or a non-autonomous vehicle. In some aspects, the capability indication may indicate that an autonomous mode of the autonomous vehicle is engaged or disengaged. In some aspects, the capability indication may be comprised within a wireless communication. The wireless communication comprising the capability indication may be transmitted via a transceiver of the UE. In some aspects, the capability indication may be comprised within a short-range wireless communication. For example, the capability indication may be comprised within a short range wireless device-to-device communication protocol (e.g., sidelink, WiFi, or DSRC). The vehicle specific signals may be comprised within at least one of application-layer messages, RRC messages, or physical-layer messages.

At 904, the UE may receive vehicle specific signals. For example, 904 may be performed by capability component 198 of apparatus 1104. The UE may receive the vehicle specific signals from the network entity. The vehicle specific signals may be based on the capability indication indicating that the UE is paired with the autonomous vehicle or the non-autonomous vehicle. In some aspects, data within the vehicle specific signals may be tailored to a paired combination of the UE and the vehicle. For example, the data within the vehicle specific signals may be tailored for the UE paired with the autonomous vehicle, or for the UE paired with the non-autonomous vehicle, or both. In instances where the vehicle comprises the autonomous vehicle and an autonomous mode of the autonomous vehicle is engaged, some of the data may correspond to one or more other vehicles, one or more road users, one or more road conditions, one or more traffic conditions, a field of view of one or more sensors, one or more depths, one or more ranges, or the like, or some combination thereof. In some aspects, in response to the vehicle comprising a non-autonomous vehicle, at least a portion of the data may comprise at least information associated with a vicinity of the non-autonomous vehicle for the UE paired with the non-autonomous vehicle. In some aspects, in response to the vehicle comprising an autonomous vehicle, at least a portion of the data may comprise at least information associated with a vicinity of the autonomous vehicle for the UE paired with the autonomous vehicle for use by the autonomous vehicle while an autonomous mode of the autonomous vehicle is disengaged. In some aspects, the vicinity of the non-autonomous vehicle for the UE paired with the non-autonomous vehicle or the vicinity of the autonomous vehicle for the UE paired with the autonomous vehicle may correspond to a field of view of an operator of the vehicle. In some aspects, in response to the vehicle comprising a non-autonomous vehicle, the data within the vehicle specific signals may be based at least in-part, on an estimated or expected reaction time of an operator of the non-autonomous vehicle. In some aspects, in response to the vehicle comprising an autonomous vehicle, the data within the vehicle specific signals may be based, at least in part, on an expected data processing capability of the autonomous vehicle, an expected reaction time of an operator of the autonomous vehicle, or both. The reception of the vehicle specific signals may comprise one or more application-layer messages, one or more RRC messages, or one or more physical-layer messages. In some aspects, a processor associated with the capability component may be configured to receive the vehicle specific signals by initiating reception of the vehicle specific signals via a transceiver.

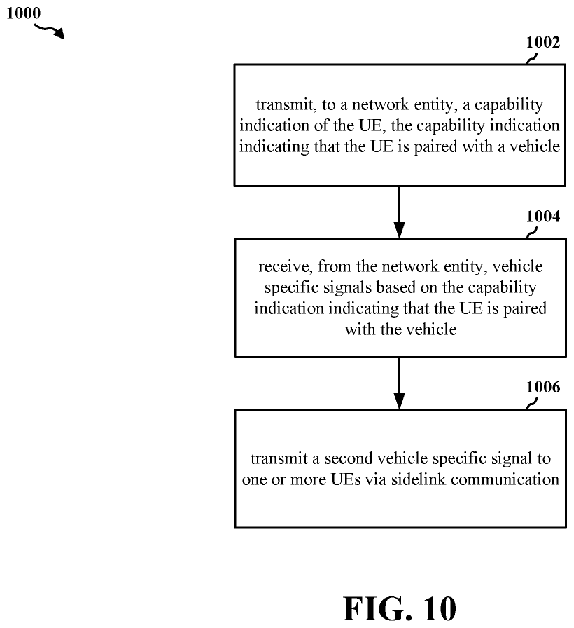

FIG. 10 is a flowchart 1000 of a method of wireless communication. The method may be performed by a UE (e.g., the UE 104; the apparatus 1104). One or more of the illustrated operations may be omitted, transposed, or contemporaneous. The method may UEs to receive vehicle specific sensor sharing data based on whether the UE is comprised within an autonomous vehicle or comprised within a non-autonomous vehicle.

At 1002, the UE may transmit a capability indication of the UE. For example, 1002 may be performed by capability component 198 of apparatus 1104. The UE may transmit the capability indication of the UE to a network entity. The capability indication may indicate that the UE is paired with a vehicle. The vehicle may comprise an autonomous vehicle or a non-autonomous vehicle. In some instances, the capability indication may indicate that the UE is paired with an autonomous vehicle or a non-autonomous vehicle. In some aspects, the capability indication may indicate that an autonomous mode of the autonomous vehicle is engaged or disengaged. In some aspects, the capability indication may be comprised within a wireless communication. The wireless communication comprising the capability indication may be transmitted via a transceiver of the UE. In some aspects, the capability indication may be comprised within a short-range wireless communication. For example, the capability indication may be comprised within a short range wireless device-to-device communication protocol (e.g., sidelink, WiFi, or DSRC). The vehicle specific signals may be comprised within at least one of application-layer messages, RRC messages, or physical-layer messages.

At 1004, the UE may receive vehicle specific signals. For example, 1004 may be performed by capability component 198 of apparatus 1104. The UE may receive the vehicle specific signals from the network entity. The vehicle specific signals may be based on the capability indication indicating that the UE is paired with the autonomous vehicle or the non-autonomous vehicle. In some aspects, data within the vehicle specific signals may be tailored to a paired combination of the UE and the vehicle. For example, the data within the vehicle specific signals may be tailored for the UE paired with the autonomous vehicle, or for the UE paired with the non-autonomous vehicle, or both. In instances where the vehicle comprises the autonomous vehicle and an autonomous mode of the autonomous vehicle is engaged, some of the data may correspond to one or more other vehicles, one or more road users, one or more road conditions, one or more traffic conditions, a field of view of one or more sensors, one or more depths, one or more ranges, or the like, or some combination thereof. In some aspects, in response to the vehicle comprising a non-autonomous vehicle, at least a portion of the data may comprise at least information associated with a vicinity of the non-autonomous vehicle for the UE paired with the non-autonomous vehicle. In some aspects, in response to the vehicle comprising an autonomous vehicle, at least a portion of the data may comprise at least information associated with a vicinity of the autonomous vehicle for the UE paired with the autonomous vehicle for use by the autonomous vehicle while an autonomous mode of the autonomous vehicle is disengaged. In some aspects, the vicinity of the non-autonomous vehicle for the UE paired with the non-autonomous vehicle or the vicinity of the autonomous vehicle for the UE paired with the autonomous vehicle may correspond to a field of view of an operator of the vehicle. In some aspects, in response to the vehicle comprising a non-autonomous vehicle, the data within the vehicle specific signals may be based at least in-part, on an estimated or expected reaction time of an operator of the non-autonomous vehicle. In some aspects, in response to the vehicle comprising an autonomous vehicle, the data within the vehicle specific signals may be based, at least in part, on an expected data processing capability of the autonomous vehicle, an expected reaction time of an operator of the autonomous vehicle, or both. The reception of the vehicle specific signals may comprise one or more application-layer messages, one or more RRC messages, or one or more physical-layer messages. In some aspects, a processor associated with the capability component may be configured to receive the vehicle specific signals by initiating reception of the vehicle specific signals via a transceiver.

At 1006, the UE may transmit a second vehicle specific signal to one or more UEs via sidelink communication. For example, 1006 may be performed by capability component 198 of apparatus 1104. In some aspects, each of the one or more UEs may be paired with a respective autonomous vehicle or a respective non-autonomous vehicle. In some aspects, vehicle specific signals may be transmitted to the one or more UEs via broadcast, groupcast, or unicast. In some aspects, the second vehicle specific signal may be processed to correspond with vehicle capabilities of the one or more UEs, based on the vehicle specific signals received from the network entity. In some aspects, the second vehicle specific signal may comprise at least a portion of vehicle specific signals received by the first UE from the network entity.

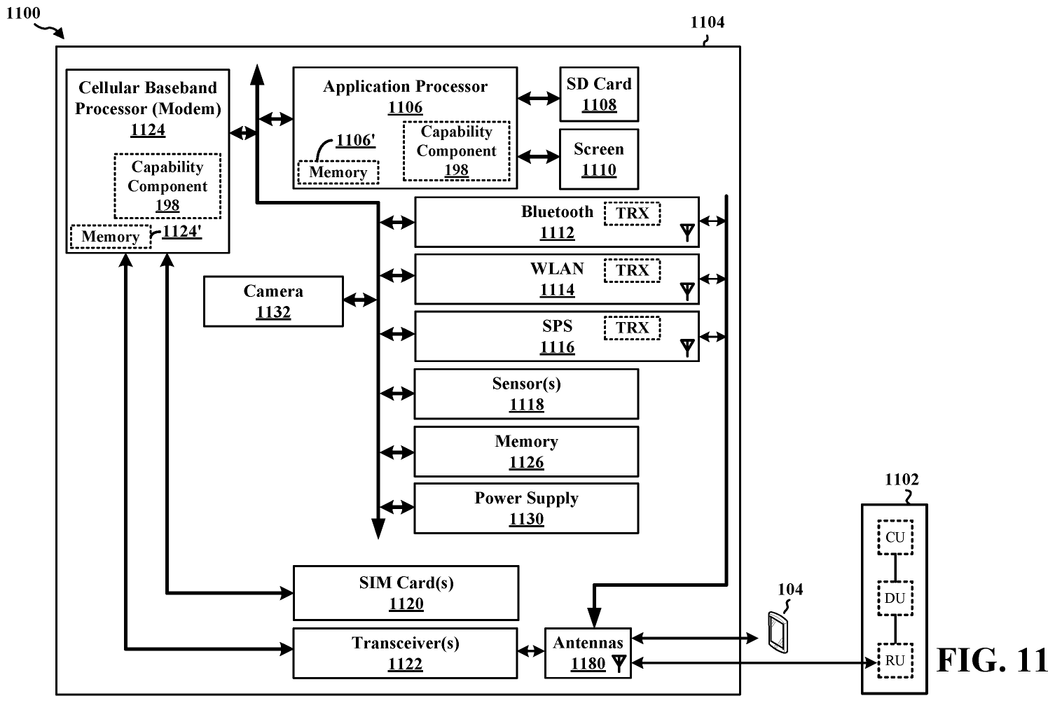

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to transmit, to a network entity, a capability indication of the UE, the capability indication indicating that the UE is paired with a vehicle; and receiving, from the network entity, vehicle specific signals based on the capability indication indicating that the UE is paired with the vehicle. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for transmitting, to a network entity, a capability indication of the UE, the capability indication indicating that the UE is paired with a vehicle. The apparatus includes means for receiving, from the network entity, vehicle specific signals based on the capability indication indicating that the UE is paired with the vehicle. The apparatus further includes means for transmitting a second vehicle specific signal to one or more UEs via sidelink communication. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity comprising obtaining a capability indication of a UE, the capability indication indicating that the UE is paired with a vehicle; generating vehicle specific signals based on the capability indication indicating that the UE is paired with the vehicle; and outputting the vehicle specific signals to the UE.

Aspect 2 is the method of aspect 1, further includes that the vehicle comprises an autonomous vehicle, and wherein the capability indication further indicates that an autonomous mode of the autonomous vehicle is engaged or disengaged.

Aspect 3 is the method of any of aspects 1 and 2, further includes that data within the vehicle specific signals is tailored for a paired combination of the UE and the vehicle.

Aspect 4 is the method of any of aspects 1-3, further includes that the vehicle comprises an autonomous vehicle and an autonomous mode of the autonomous vehicle is engaged, and wherein the data corresponds to one or more other vehicles, one or more road users, one or more road conditions, one or more traffic conditions, a field of view of one or more sensors, one or more depths, one or more ranges, or some combination thereof.

Aspect 5 is the method of any of aspects 1-4, further includes that in response to the vehicle comprising a non-autonomous vehicle, the data comprises at least information associated with a vicinity of the non-autonomous vehicle for the UE paired with the non-autonomous vehicle, or in response to the vehicle comprising an autonomous vehicle, the data comprises at least information associated with a vicinity of the autonomous vehicle for the UE paired with the autonomous vehicle for use by the autonomous vehicle while an autonomous mode of the autonomous vehicle is disengaged.

Aspect 6 is the method of any of aspects 1-5, further includes that the vicinity of the non-autonomous vehicle for the UE paired with the non-autonomous vehicle or the vicinity of the autonomous vehicle for the UE paired with the autonomous vehicle corresponds to an estimated field of view of an operator of the vehicle.

Aspect 7 is the method of any of aspects 1-6, further includes that in response to the vehicle comprising a non-autonomous vehicle, the data within the vehicle specific signals is based, at least in part, on an expected reaction time of an operator of the non-autonomous vehicle, or in response to the vehicle comprising an autonomous vehicle, the data within the vehicle specific signals is based, at least in part, on an expected data processing capability of the autonomous vehicle, an expected reaction time of an operator of the autonomous vehicle, or both.

Aspect 8 is the method of any of aspects 1-7, further includes that the capability indication is comprised within a wireless communication received via a transceiver.

Aspect 9 is the method of any of aspects 1-8, further includes that the transmission of the vehicle specific signals comprises one or more application-layer messages, one or more RRC messages, or one or more physical-layer messages.

Aspect 10 is the method of any of aspects 1-9, further includes that the capability indication is comprised within a short-range wireless communication, wherein the vehicle specific signals are comprised within at least one of application-layer messages, RRC messages, or physical-layer messages.

Aspect 11 is the method of any of aspects 1-10, further includes that the vehicle comprises an autonomous vehicle or a non-autonomous vehicle.

Aspect 12 is the method of any of aspects 1-11, further includes that to output the vehicle specific signals by initiating transmission of the vehicle specific signals via a transceiver.

Aspect 13 is an apparatus for wireless communication at a network entity including at least one processor coupled to a memory and at least one transceiver, the at least one processor configured to implement any of Aspects 1-12.

Aspect 14 is an apparatus for wireless communication at a network entity including means for implementing any of Aspects 1-12.

Aspect 15 is a computer-readable medium storing computer executable code, where the code when executed by a processor causes the processor to implement any of Aspects 1-12.

Aspect 16 is a method of wireless communication at a UE comprising transmitting, to a network entity, a capability indication of the UE, the capability indication indicating that the UE is paired with a vehicle; and receiving, from the network entity, vehicle specific signals based on the capability indication indicating that the UE is paired with the vehicle.

Aspect 17 is the method of aspect 16, further includes that the vehicle comprises an autonomous vehicle, and wherein the capability indication further indicates that an autonomous mode of the autonomous vehicle is engaged or disengaged.

Aspect 18 is the method of any of aspects 16 and 17, further includes that data within the vehicle specific signals is tailored to a paired combination of the UE and the vehicle.

Aspect 19 is the method of any of aspects 16-18, further includes that the vehicle comprises an autonomous vehicle and an autonomous mode of the autonomous vehicle is engaged, and wherein the data corresponds to one or more other vehicles, one or more road users, one or more road conditions, one or more traffic conditions, a field of view of one or more sensors, one or more depths, one or more ranges, or some combination thereof.

Aspect 20 is the method of any of aspects 16-19, further includes that in response to the vehicle comprising a non-autonomous vehicle, the data comprises at least information associated with a vicinity of the non-autonomous vehicle for the UE paired with the non-autonomous vehicle, or in response to the vehicle comprising an autonomous vehicle, the data comprises at least information associated with a vicinity of the autonomous vehicle for the UE paired with the autonomous vehicle for use by the autonomous vehicle while an autonomous mode of the autonomous vehicle is disengaged, wherein the vicinity of the non-autonomous vehicle for the UE paired with the non-autonomous vehicle or the vicinity of the autonomous vehicle for the UE paired with the autonomous vehicle corresponds to an estimated field of view of an operator of the vehicle.

Aspect 21 is the method of any of aspects 16-20, further includes that in response to the vehicle comprising a non-autonomous vehicle, the data within the vehicle specific signals is based, at least in part, on an expected reaction time of an operator of the non-autonomous vehicle, or in response to the vehicle comprising an autonomous vehicle, the data within the vehicle specific signals is based, at least in part, on an expected data processing capability of the autonomous vehicle, an expected reaction time of an operator of the autonomous vehicle, or both.

Aspect 22 is the method of any of aspects 16-21, further includes that the capability indication is comprised within a wireless communication transmitted via a transceiver.

Aspect 23 is the method of any of aspects 16-22, further includes that the reception of the vehicle specific signals comprises one or more application-layer messages, one or more RRC messages, or one or more physical-layer messages.

Aspect 24 is the method of any of aspects 16-23, further includes that the capability indication is comprised within a short-range wireless communication, wherein the vehicle specific signals are comprised within at least one of application-layer messages, RRC messages, or physical-layer messages.

Aspect 25 is the method of any of aspects 16-24, further includes that the vehicle comprises an autonomous vehicle or a non-autonomous vehicle.

Aspect 26 is the method of any of aspects 16-25, further including transmitting a second vehicle specific signal to one or more UEs via sidelink communication.

Aspect 27 is the method of any of aspects 16-26, further includes that each of the one or more UEs are paired with a respective autonomous vehicle or a respective non-autonomous vehicle.

Aspect 28 is the method of any of aspects 16-27, further includes that the vehicle specific signals transmitted to the one or more UEs are transmitted via broadcast, groupcast, or unicast.

Aspect 29 is the method of any of aspects 16-28, further includes that the second vehicle specific signal is processed to correspond with vehicle capabilities of the one or more UEs, based on the vehicle specific signals received from the network entity.

Aspect 30 is the method of any of aspects 16-29, further includes that the second vehicle specific signal comprise the vehicle specific signals received from the network entity.

Aspect 31 is the method of any of aspects 16-30, further includes that to receive the vehicle specific signals by initiating reception of the vehicle specific signals via the transceiver.

Aspect 32 is an apparatus for wireless communication at a UE including at least one processor coupled to a memory and at least one transceiver, the at least one processor configured to implement any of Aspects 16-31.

Aspect 33 is an apparatus for wireless communication at a UE including means for implementing any of Aspects 16-31.

Aspect 34 is a computer-readable medium storing computer executable code, where the code when executed by a processor causes the processor to implement any of Aspects 16-31.

What is claimed is:

1. An apparatus for wireless communication at a network entity, comprising:
a memory; and
at least one processor coupled to the memory and, based at least in part on information stored in the memory, the at least one processor is configured to:
obtain a capability indication of a user equipment (UE), the capability indication indicating that the UE is paired with a vehicle;
generate vehicle specific signals based on the capability indication indicating that the UE is paired with the vehicle; and
output the vehicle specific signals to the UE.

2. The apparatus of claim 1, further comprising a transceiver coupled to the at least one processor, and wherein the at least one processor is configured to output the vehicle specific signals by initiating transmission of the vehicle specific signals via the transceiver.

3. The apparatus of claim 1, wherein the vehicle comprises an autonomous vehicle, and wherein the capability indication further indicates that an autonomous mode of the autonomous vehicle is engaged or disengaged.

4. The apparatus of claim 1, wherein data within the vehicle specific signals is tailored for a paired combination of the UE and the vehicle.

5. The apparatus of claim 4, wherein the vehicle comprises an autonomous vehicle and an autonomous mode of the autonomous vehicle is engaged, and wherein the data corresponds to one or more other vehicles, one or more road users, one or more road conditions, one or more traffic conditions, a field of view of one or more sensors, one or more depths, one or more ranges, or some combination thereof.

6. The apparatus of claim 4, wherein:
i) in response to the vehicle comprising a non-autonomous vehicle, the data comprises at least information associated with a vicinity of the non-autonomous vehicle for the UE paired with the non-autonomous vehicle, or
ii) in response to the vehicle comprising an autonomous vehicle, the data comprises at least information associated with a vicinity of the autonomous vehicle for the UE paired with the autonomous vehicle for use by the autonomous vehicle while an autonomous mode of the autonomous vehicle is disengaged.

7. The apparatus of claim 6, wherein the vicinity of the non-autonomous vehicle for the UE paired with the non-autonomous vehicle or the vicinity of the autonomous vehicle for the UE paired with the autonomous vehicle corresponds to a field of view of an operator of the vehicle.

8. The apparatus of claim 4, wherein:
i) in response to the vehicle comprising a non-autonomous vehicle, the data within the vehicle specific signals is based, at least in part, on an expected reaction time of an operator of the non-autonomous vehicle, or
ii) in response to the vehicle comprising an autonomous vehicle, the data within the vehicle specific signals is based, at least in part, on an expected data processing capability of the autonomous vehicle, an expected reaction time of an operator of the autonomous vehicle, or both.

9. The apparatus of claim 2, wherein the capability indication is comprised within a wireless communication received via the transceiver.

10. The apparatus of claim 9, wherein the transmission of the vehicle specific signals comprises one or more application-layer messages, one or more radio resource control (RRC) messages, or one or more physical-layer messages.

11. The apparatus of claim 2, wherein the capability indication is comprised within a short-range wireless communication, wherein the vehicle specific signals are comprised within at least one of application-layer messages, radio resource control (RRC) messages, or physical-layer messages.

12. The apparatus of claim 1, wherein the vehicle comprises an autonomous vehicle or a non-autonomous vehicle.

13. A method of wireless communication at a network entity, comprising:
obtaining a capability indication of a user equipment (UE), the capability indication indicating that the UE is paired with a vehicle;
generating vehicle specific signals based on the capability indication indicating that the UE is paired with the vehicle; and
outputting the vehicle specific signals to the UE.

14. An apparatus for wireless communication at a user equipment (UE), comprising:
a memory; and
at least one processor coupled to the memory and, based at least in part on information stored in the memory, the at least one processor is configured to:
transmit, to a network entity, a capability indication of the UE, the capability indication indicating that the UE is paired with a vehicle; and
receive, from the network entity, vehicle specific signals based on the capability indication indicating that the UE is paired with the vehicle.

15. The apparatus of claim 14, further comprising a transceiver coupled to the at least one processor, and wherein the at least one processor is configured to receive the vehicle specific signals by initiating reception of the vehicle specific signals via the transceiver.

16. The apparatus of claim 14, wherein the vehicle comprises an autonomous vehicle, and wherein the capability indication further indicates that an autonomous mode of the autonomous vehicle is engaged or disengaged.

17. The apparatus of claim 14, wherein data within the vehicle specific signals is tailored to a paired combination of the UE and the vehicle.

18. The apparatus of claim 17, wherein the vehicle comprises an autonomous vehicle and an autonomous mode of the autonomous vehicle is engaged, and wherein the data corresponds to one or more other vehicles, one or more road users, one or more road conditions, one or more traffic conditions, a field of view of one or more sensors, one or more depths, one or more ranges, or some combination thereof.

19. The apparatus of claim 17, wherein:
i) in response to the vehicle comprising a non-autonomous vehicle, the data comprises at least information associated with a vicinity of the non-autonomous vehicle for the UE paired with the non-autonomous vehicle, or
ii) in response to the vehicle comprising an autonomous vehicle, the data comprises at least information associated with a vicinity of the autonomous vehicle for the UE paired with the autonomous vehicle for use by the autonomous vehicle while an autonomous mode of the autonomous vehicle is disengaged,
wherein the vicinity of the non-autonomous vehicle for the UE paired with the non-autonomous vehicle or the vicinity of the autonomous vehicle for the UE paired with the autonomous vehicle corresponds to a field of view of an operator of the vehicle.

20. The apparatus of claim 17, wherein:
i) in response to the vehicle comprising a non-autonomous vehicle, the data within the vehicle specific signals is based, at least in part, on an expected reaction time of an operator of the non-autonomous vehicle, or
ii) in response to the vehicle comprising an autonomous vehicle, the data within the vehicle specific signals is based, at least in part, on an expected data processing capability of the autonomous vehicle, an expected reaction time of an operator of the autonomous vehicle, or both.

21. The apparatus of claim 15, wherein the capability indication is comprised within a wireless communication transmitted via the transceiver.

22. The apparatus of claim 21, wherein the reception of the vehicle specific signals comprises one or more application-layer messages, one or more radio resource control (RRC) messages, or one or more physical-layer messages.

23. The apparatus of claim 15, wherein the capability indication is comprised within a short-range wireless communication, wherein the vehicle specific signals are comprised within at least one of application-layer messages, radio resource control (RRC) messages, or physical-layer messages.

24. The apparatus of claim 14, wherein the vehicle comprises an autonomous vehicle or a non-autonomous vehicle.

25. The apparatus of claim 14, wherein the at least one processor is further configured to:
transmit a second vehicle specific signal to one or more UEs via sidelink communication.

26. The apparatus of claim 25, wherein each of the one or more UEs are paired with a respective autonomous vehicle or a respective non-autonomous vehicle.

27. The apparatus of claim 25, wherein the vehicle specific signals transmitted to the one or more UEs are transmitted via broadcast, groupcast, or unicast.

28. The apparatus of claim 25, wherein the second vehicle specific signal is processed to correspond with vehicle capabilities of the one or more UEs, based on the vehicle specific signals received from the network entity.

29. The apparatus of claim 25, wherein the second vehicle specific signal comprise the vehicle specific signals received from the network entity.

30. A method of wireless communication at a user equipment (UE), comprising:
transmitting, to a network entity, a capability indication of the UE, the capability indication indicating that the UE is paired with a vehicle; and
receiving, from the network entity, vehicle specific signals based on the capability indication indicating that the UE is paired with the vehicle.
